(19) United States
(12) Patent Application Publication
(10) Pub. No.: US 2006/0245585 A1
(43) Pub. Date: Nov. 2, 2006

(54) Portable computer device with wireless earpiece

(76) Inventors: Memphis-Zhihong Yin, Houston, TX (US); Stacy L. Wolff, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/399,981

(22) Filed: Apr. 7, 2006

Related U.S. Application Data
(60) Provisional application No. 60/676,432, filed on Apr. 29, 2005.

(51) Int. Cl. H04M 1/00

(52) U.S. Cl. 379/430

(57) ABSTRACT

A portable computer device comprises a wireless earpiece configured to be detachable from the portable computer device.

### RELATED APPLICATIONS

The present patent application claims priority to U.S. Provisional Patent Application No. 60/676,432 entitled “Portable Computer Device with Wireless Earpiece”, filed on Apr. 29, 2005.

### BACKGROUND OF THE INVENTION

Using wireless devices, such as a headset, with various types of portable computer devices is generally troublesome. For example, a headset is a relatively large, stand-alone device that is separately transported. Further, the wireless headset requires its own battery charger, which results in an additional device to transport and increased inconvenience.

### BRIEF DESCRIPTION OF THE DRAWINGS

FIG. 1 is a diagram illustrating an embodiment of a portable computer device having a wireless earpiece in accordance with the present invention;

FIG. 2 is a diagram illustrating a plan view of a base member of the device illustrated in FIG. 1; and

FIGS. 3A and 3B are diagrams illustrating an embodiment of the earpiece and base member illustrated in FIGS. 1 and 2 in accordance with the present invention.

### DETAILED DESCRIPTION OF THE DRAWINGS

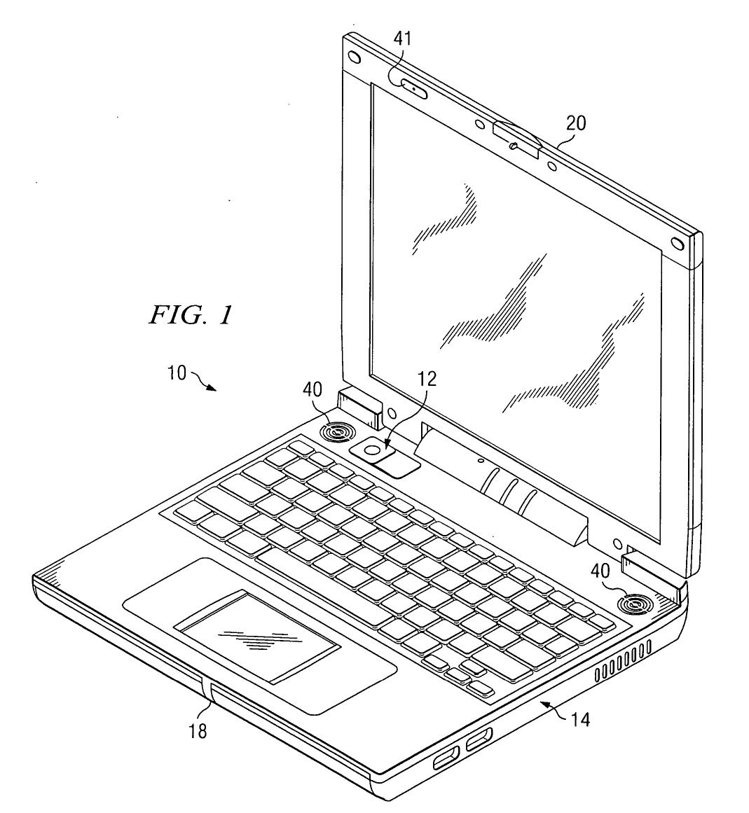

FIG. 1 is a diagram illustrating an embodiment of a portable computer device 10 having a detachable wireless transceiver or earpiece 12 in accordance with the present invention. In the embodiment illustrated in FIG. 1, portable computer device 10 comprises a laptop or notebook computer device 14. However, it should be understood that portable computer device 10 may comprise other types of electronic devices such as, but not limited to, a personal digital assistant or a tablet portable computer.

In the embodiment illustrated in FIG. 1, portable computer device 10 comprises a base member 18 and a display member 20 rotatably coupled to base member 18. In the embodiment illustrated in FIG. 1, earpiece 12 is integrated with and/or otherwise stored in base member 18. However, it should be understood that earpiece 12 may be otherwise stored in portable computer device 10 (e.g., in display member 20 or elsewhere). Preferably, earpiece 12 is configured to be worn comfortably and unobtrusively by a user (e.g., insertable into a user's ear) in a relatively compact form to facilitate convenient storage of earpiece 12 in base member 18. However, various configurations of earpiece 12 may be used. Preferably, earpiece 12 is configured having a speaker component (e.g., to facilitate transmission of audio signals to a user's ear) configured separately from or in combination with a microphone component (e.g., to facilitate transmission of vocal communications from the user to device 14 and/or another device). However, it should be understood that earpiece 12 may be otherwise configured.

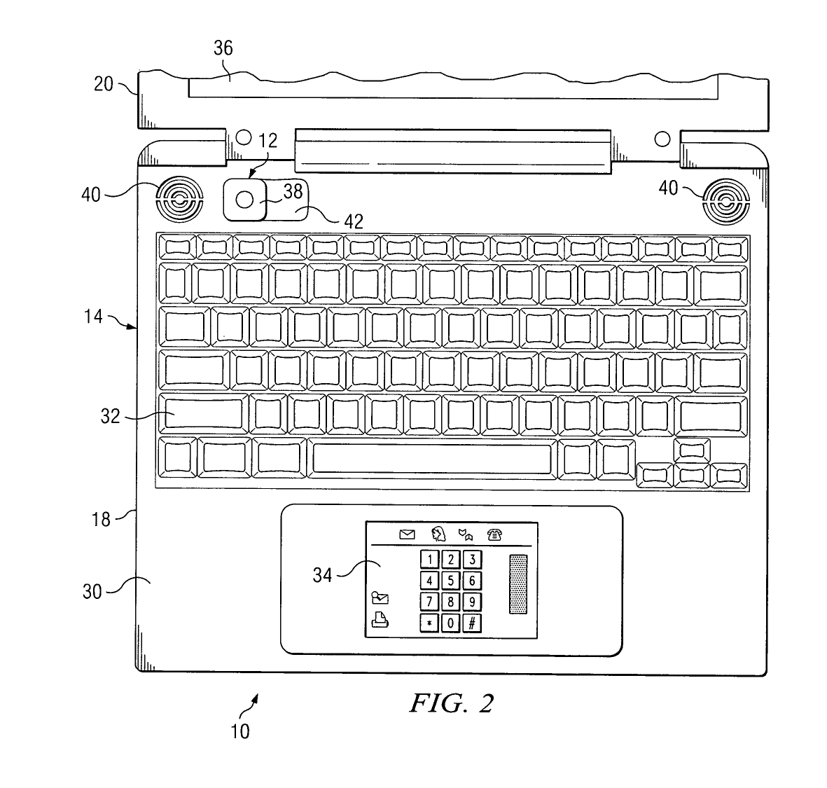

FIG. 2 is a diagram illustrating a plan view of base member 18 of portable computer device 10. In the embodiment illustrated in FIG. 2, base member 18 comprises a working surface 30 facing generally upwards to facilitate use thereby by a user of portable computer device 10. For example, in the embodiment illustrated in FIG. 1, working surface 30 comprises a keyboard 32 and a user interface 34. However, it should be understood that additional elements and/or devices may be implemented on working surface 30. In the embodiment illustrated in FIG. 2, earpiece 12 is integrated within base member 18 and accessible via working surface 30 to a user of portable computer device 10. For example, in the embodiment illustrated in FIG. 2, earpiece 12 resides within base member 18 at a position between keyboard 32 and a location attaching display member 20 to base member 18. However, it should be understood that earpiece 12 may be otherwise located on base member 18.

In operation, portable computer device 10 is implemented with software, hardware, or a combination thereof, to facilitate wireless communications between portable computer device 10 and other devices and/or systems (e.g., a wireless telephone network, the Internet, or an intranet). In some embodiments of the present invention, portable computer device 10 is configured having a microphone and speakers (e.g., speaker(s) located adjacent and/or on opposite sides of a display device 36 of display member 20 or located on base member 18, such as on opposite sides of working surface 30 adjacent keyboard 32 or between keyboard 32 and a location attaching display member 20 to base member 18 (e.g., such as the location of speakers 40 (FIGS. 1 and 2)), and a microphone disposed on an edge or face of display member 20 facing a user of device 14 (e.g., such as the location of microphone 41 (FIG. 1)) or centrally disposed on working surface 30 between keyboard 32 and a location attaching display member 20 to base member 18) to facilitate audio communications between portable computer device 10 and a user of portable computer device 10. In the embodiment illustrated in FIG. 2, user interface 34 is configured to enable a user of computer device 10 to engage and/or otherwise utilize various wireless capabilities of portable computer device 10 such as, but not limited to, initiating and/or receiving wireless communications such as, but not limited to, phone calls or the Internet. It should also be understood that keyboard 32, display device 36 of display member 20 and/or other devices or elements of portable device 10 may be used to engage and/or utilize various wireless capabilities of portable computer device 10.

In the embodiment illustrated in FIG. 2, earpiece 12 and/or base member 18 are configured to enable storage of earpiece 12 within base member 18 to enable closing of display member 20 relative to base member 18 such that, when earpiece 12 is disposed within base member 18, a top portion 38 of earpiece 12 is disposed flush or below working surface 30. It should also be understood that earpiece 12 and/or base member 18 may be configured such that top portion 38 of earpiece 12 extends slightly above working surface 30 when earpiece 12 is disposed within base member so as not to impede closing of display member 20 relative to base member 18. Embodiments of the present invention also enable ready removal of earpiece 12 from base member 18 for use thereof. In some embodiments of the present invention, base member 18 is configured having an eject mechanism 42 to facilitate ejection of earpiece 12 from base member 18 and/or otherwise enable a user to remove earpiece 12 from base member 18. However, it should be understood that earpiece 12 and/or base member 18 may be otherwise configured or manufactured to enable releasable engagement of earpiece 12 with base member 18, such as, but not limited to, a push-push locking mechanism.

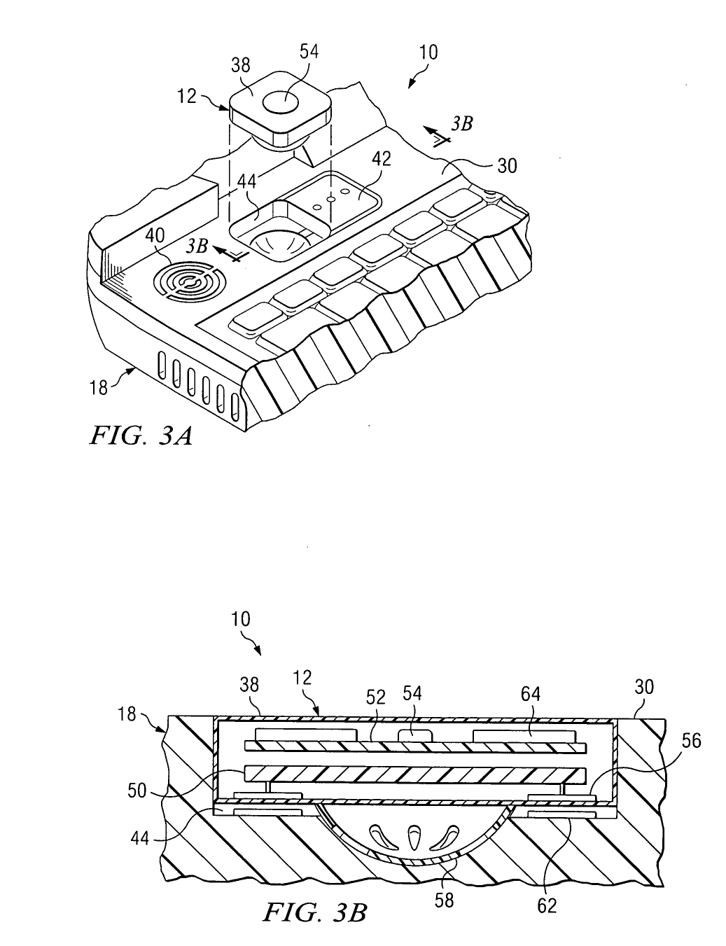

FIGS. 3A and 3B are diagrams illustrating an embodiment of earpiece 12 and base member 18 in accordance with the present invention. In the embodiment illustrated in FIGS. 3A and 3B, base member 18 comprises a storage pocket or compartment 44 configured to cooperate and receive earpiece 12 therein such that, preferably, when earpiece 12 is disposed therein, top portion 38 is disposed flush or below working surface 30. However, it should be understood that in some embodiments of the present invention, earpiece 12 and/or compartment 44 is configured such that top portion 38 is slightly elevated relative to working surface 30. Referring to FIG. 3B, earpiece 12 preferably comprises a rechargeable battery 50, a printed circuit board 52, a light emitting diode (LED) 54, contact elements 56, and a speaker/microphone 58. Contact elements 56 are configured to engage corresponding contact elements 62 disposed within compartment 44 to facilitate recharging of battery 50 via device 14 while earpiece 12 is disposed within compartment 44. Printed circuit board 52 generally comprises an antenna, software, hardware, or a combination of software and hardware, to facilitate wireless data communications between earpiece 12 and device 14. For example, in the embodiment illustrated in FIGS. 3A and 3B, earpiece 12 comprises a Bluetooth module 64 to enable wireless communications between earpiece 12 and device 14 via the Bluetooth communication protocol or standard and/or between earpiece 12 and another device (e.g., a cellular telephone or other type of portable device). However, it should be understood that other types of wireless communications and/or protocols may be used for wireless communications between earpiece 12 and device 14. In the embodiment illustrated in FIGS. 3A and 3B, LED 54 is configured to emit light during recharging of battery 50, in response to an incoming telephone call and/or during data communications exchange between earpiece 12 and device 14. However, it should be understood that earpiece 12 may be otherwise configured such that LED 54 emits light during other processing functions and/or emits different color lights for different processes or applications. It should also be understood that earpiece 12 may be configured without LED 54 or with additional LEDs.

In operation, earpiece 12 facilitates wireless communications with device 14 by a user of portable computer device 10 and/or another device (e.g., a cellular telephone or other type of portable or non-portable device). For example, in some embodiments of the present invention, earpiece 12 is used by a user of portable computer device 10 to initiate and/or otherwise engage a variety of types of wireless communications. For example, in a telephone application, in response to an incoming telephone call, release of earpiece 12 from compartment 44 enables earpiece 12 to be used to engage and/or otherwise receive the incoming telephone call and/or otherwise automatically initiate the wireless functions of the earpiece 12 relative to device 14. In other embodiments of the present invention, engagement of an incoming call may be performed via user interface 34, display device 36 (e.g., clicking on a display graphical icon), or other means via the microphone (e.g., microphone 41) and/or speakers (e.g., speakers 40) of device 14, which call may then be continued via earpiece 12 in response to removal of earpiece 12 from compartment 44 or otherwise. In some embodiments of the present invention, user interface 34, display device 36, or another device or element of device 14 is used to initiate a wireless communication via device 14 with earpiece 12 disposed within or out of compartment 44. It should be understood that earpiece 12 may also be used for wireless communications solely between earpiece 12 and device 14 (e.g., receiving audio signals corresponding to an application executing on device 14 such as, but not limited to, audio signals corresponding to an audio file or film clip).

In some embodiments of the present invention, earpiece 12 and/or device 14 is configured to enable turning on or off at least one of the speakers (e.g., speakers 40) and/or a microphone (e.g., microphone 41) of device 14 in response to use of earpiece 12 and/or removal of earpiece 12 from compartment 44. For example, in a conference call application, a microphone (e.g., microphone 41) and/or speakers (e.g., speakers 40) of device 14 may be initially used to communicate with another party. However, in response to a desire to communicate privately with such party, retrieval of earpiece 12 from compartment 44 automatically turns off the microphone (e.g., microphone 41) and/or speakers (e.g., speakers 40) of device 14 such that continued communications are processed automatically via earpiece 12. Additionally, or alternatively, turning off microphone 41 and/or speakers 40 of device 14 may be accomplished via engagement or interaction with other components of device 14 (e.g., clickable icon, keystroke, button, etc.).

Thus, embodiments of the present invention provide a wireless earpiece 12 that facilitates convenient storage thereof within a portable computer device. Further, embodiments of the present invention enable storage of the earpiece 12 in the device inconspicuously and without obstructing use of the device. For example, when earpiece 12 is stored within compartment 44, earpiece 12 resides flush or below working surface 30, thereby not interfering with a user's use or interaction with other elements or functions of device 14.

What is claimed is:

1. A portable computer device, comprising:
a wireless earpiece configured to be detachable from the portable computer device.

2. The device of claim 1, wherein the wireless earpiece is detachable from a base member of the portable computer device.

3. The device of claim 1, wherein the wireless earpiece is configured to be disposed within a storage compartment of the portable computer device.

4. The device of claim 1, wherein the wireless earpiece comprises a rechargeable battery.

5. The device of claim 1, wherein removal of the wireless earpiece from a storage compartment of the portable computer device automatically initiates wireless communications between the wireless earpiece and the portable computer device.

6. The device of claim 1, wherein the earpiece is configured to facilitate wireless communications between the earpiece and the portable computer device.

7. The device of claim 1, wherein removal of the wireless earpiece from a storage compartment of the portable computer device automatically turns off at least one speaker of the portable computer device.

8. The device of claim 1, wherein the earpiece is configured to wirelessly communicate with the portable computer device via Bluetooth communication protocol.

9. The device of claim 1, further comprising an eject mechanism configured to facilitate ejection of the wireless earpiece from the portable computer device.

10. A portable computer device, comprising:
means for storing a detachable wireless earpiece means in the portable computer device.

11. The device of claim 10, further comprising means for ejecting the wireless earpiece means from the storing means.

12. The device of claim 10, further comprising means for automatically initiating wireless communications between the wireless earpiece means and the portable computer device in response to removal of the wireless earpiece means from the storing means.

13. The device of claim 10, further comprising means for automatically turning off at least one speaker means of the portable computer device in response to removal of the wireless earpiece means from the storing means.
